(19) United States
(12) Patent Application Publication
(10) Pub. No.: US 2007/0163962 A1
(43) Pub. Date: Jul. 19, 2007

(54) Fraction collection in high performance liquid chromatography

(76) Inventors: Brian A. Bidlingmeyer, Frazer, PA (US); Wesley Miles Norman, Landenberg, PA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/332,623

(22) Filed: Jan. 13, 2006

(51) Int. Cl. B01D 15/08

(52) U.S. Cl. 210/656; 210/198.2; 210/141; 73/61.56

(57) ABSTRACT

A system and method for substantially continuous fraction collection includes a control device and a fluidic switch. The control device selects the state of the fluidic switch, and thereby determines which of a plurality of output ports effluent will exit.

### BACKGROUND

High performance liquid chromatography is a process by which a substance may be separated into its constituent ions or molecules. Typically, the substance is dissolved in a solvent and is driven through a column by a pump. The column is filled with a packing material known as a “stationary phase.” The various components of the solution pass through the stationary phase at different rates, due to their interaction with the stationary phase. Stated another way, the various components are retained in the column for varying durations. Therefore, the various components may be separated by collecting samples of the solution as it exits the column, because the composition of the fluid exiting the column is a function of time. The output of the column may be fed to a detector, such as an ultraviolet detector, in order to detect the presence of an analyte in the column effluent.

After measurement by the detector, the effluent may be directed through a tube that that terminates in an outlet, which is oriented over a drain. A collection system orients a collection device, such as a vial or dish, under the outlet, so as to collect the effluent exiting the tube. A computer system interfaces with the detector in order to associate a particular collection device with the time period during which it was filled (and usually with other data, as well). After a period of time, the collection device is removed from the filling area, and another collection device is positioned under the outlet.

The aforementioned scheme exhibits certain shortcomings. For example, as a collection device is removed from the filling area, effluent continues to exit the tube, and spills into the drain, until the next collection is moved into place to collect the next sample. The quantity spilled into the drain is therefore wasted. To prevent such waste, the tube may be terminated by a valve, which is closed, while one collection device is removed and another positioned in the filling area. However, such a strategy exacerbates band broadening as further described below.

Ideally, if a collection device is positioned in the filling area between times t₀ and t₀+Δ, the contents of the collection device exhibit a compositional variance that is a function of Δ. In other words, by virtue of collecting effluent over a span of time equal to Δ, the collection device commingles effluent exiting the detector over a span of time equal to Δ. However, introduction of a valve causes further commingling. For example, the valve may have a large internal volume, effectively creating a pool within the valve in which effluents from differing time periods commingle. Further, the mechanical action of the valve tends to stir the effluent in an unpredictable way, again leading to further commingling. Therefore, in a given collection device, the compositional variance is broadened, an effect known as band broadening. Band broadening is inimical to the goal of accurate substance analysis, and it is therefore desirable to minimize band broadening.

### SUMMARY

In general terms, this document directed to a fluidic switch having an input port, multiple output ports, and multiple states that determine which of the output ports is active.

In one aspect, a method of fraction collection includes providing a fluid stream including an analyte to a fluidic switch having a first output port and a second output port. Steering fluid is provided to the fluidic switch, so as to selectively steer the analyte to a selected one of the first or second output ports. The analyte is collected from the selected output port in a first collection device. A second collection device is moved under the unselected output port of the switch during at least a portion of time during which the analyte is being collected.

According to another aspect, a system for fraction collection includes a fluidic switch having a first output port and a second output port. The fluidic switch is configured to receive a fluid stream from a liquid chromatography device via a fluid stream input port. The fluidic switch may be controlled to be in a first state in which the fluid stream is steered to the first output port, or a second state in which the fluid stream is steered to the second output port. A control device determines the state of the fluidic switch, and thus determining whether the fluid stream exits the fluidic switch via the first output port or the second output port.

### BRIEF DESCRIPTION OF THE DRAWINGS

FIG. 1 depicts a system for continuous fraction collection, according to one possible embodiment.

FIG. 2 depicts another system for continuous fraction collection, according to one possible embodiment.

FIG. 3 depicts a method of carrying out continuous fraction collection, according to one possible embodiment.

FIG. 4 depicts another system for continuous fraction collection, according to one possible embodiment.

FIG. 5 depicts another system for continuous fraction collection, according to one possible embodiment.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

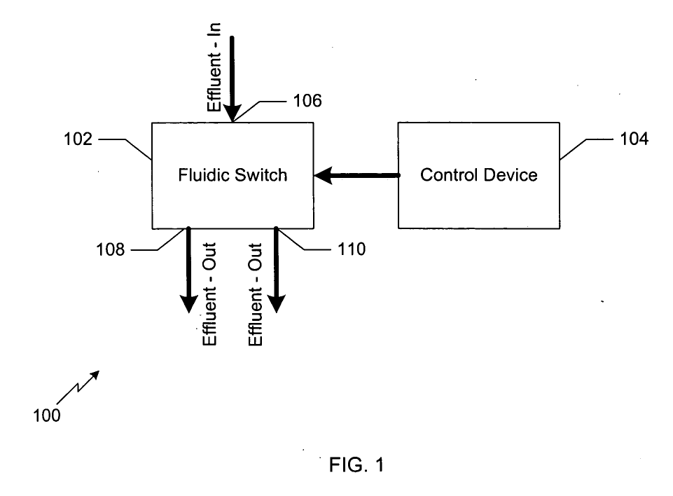

FIG. 1 depicts a system 100 for continuous fraction collection. The system 100 includes a fluidic switch 102 and a control device 104. As depicted, the fluidic switch 102 includes an input port 106 and two output ports 108 and 110. In principle, the fluidic switch 102 may possess any number of output ports, but is described herein as including two output ports 108 and 110 for the sake of illustration.

During operation, column effluent from a liquid chromatograph is supplied (e.g., pumped) through the fluidic switch 102, entering the fluidic switch 102 by way of the input port 106. The effluent exits the switch through either the first output port 108 or the second output port 110. The output port 108 or 110 from which the effluent exits is determined by the state of the fluidic switch 102. The state of the fluidic switch 102 may be determined by the control device 104. Thus, by virtue of determining the state of the fluidic switch 102, the control device 104 selects which of the two output ports 108 or 110 is to be active (i.e., from which output port 108 or 110 chromatographic effluent is to exit). For example, the state of the fluidic switch 102 may be determined by causing a pressure gradient to be exhibited between the input port 106 and one of the output ports 108 and 110 of the fluidic switch 102 (an exemplary embodiment describing how this is accomplished is presented below); the chromatographic effluent therefore travels a course determined by the pressure gradient, and exits the fluidic switch 102 via the selected output port 108 or 110.

To accomplish continuous fraction collection, the system 100 of FIG. 1 may be used in the following way. The control device 104 determines the state of the fluidic switch 102. As mentioned previously, the control device 104 may cause a pressure gradient to be exhibited between the input port 106 and one of the output ports 108 and 110 of the fluidic switch 102; the chromatographic effluent therefore travels a course determined by the pressure gradient, and exits the fluidic switch 102 via the selected output port 108 or 110. For example, the control device 104 puts the fluidic switch 102 into a first state, whereby the first output port 108 is active, meaning that effluent injected into the switch 102 exits by way of the first output port 108. A collection device (not depicted in FIG. 1), such as a vial or dish, is positioned at a location whereby it collects effluent exiting the active output port (in the context of this example, the active port is the first output port 108). For example, the collection device may be positioned beneath the first output port 108.

Given the above-recited arrangement, chromatographic effluent enters the fluidic switch 102 through the input port 106, exits by way of the first output port 108, and is collected by a collection device located at a filling position proximate to the first output port 108. The collection device may remain at the filling position for a period of time as short as approximately one second, or any period of time greater than one second, during which time, the collection device receives effluent from the fluidic switch 102.

At some point while the collection device is receiving the chromatographic effluent, a second collection device is moved into a filling position proximate the second output port 110. After the second collection device is located at the second filling position, the control device 104 puts the fluidic switch 102 into a second state, whereby the second output port 110 becomes active, and the first output port 108 becomes inactive. Therefore, chromatographic effluent enters the fluidic switch 102 through the input port 106, exits by way of the second output port 110, and is collected by the second collection device located at the filling position proximate to the second output port 110. While the second collection device is receiving the chromatographic effluent, the first collection device is removed from its filling position, and another collection device is restored to that filling position, in place of the first collection device. Thereafter, the control device 104 returns the fluidic switch 102 to its first state, and the effluent exits by way of the first output port 108. Thus, the fluidic switch 102 may be controlled to direct the chromatographic effluent in an alternating first-output-port-second-output-port-first-output-port pattern.

The effect of the foregoing embodiment is that chromatographic effluent may be collected continuously. In other words, effluent is always being collected—either from the first output port, or from the second output port. Further, no effluent is lost, because a collection device is already positioned to receive the effluent from an output port, prior to the output port becoming active. Finally, because the device used to accomplish the switching is a fluidic switch 102, the effluent is not subjected to mechanical switching forces that cause stirring effects or other perturbations of its flow.

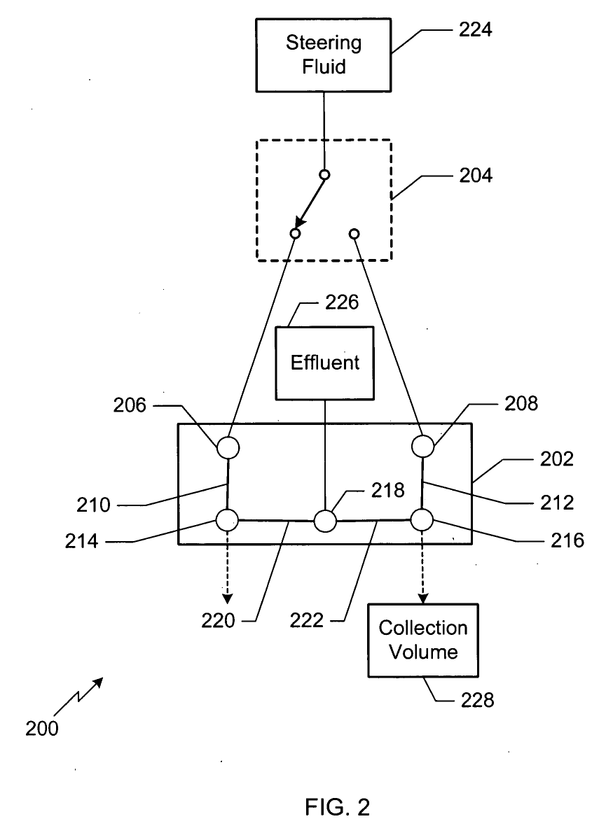

FIG. 2 depicts one possible embodiment of the system 100 of FIG. 1. Like the system of FIG. 1, the system 200 of FIG. 2 includes a fluidic switch 202 and a control device 204. As discussed in some detail below, the control device 204 is a mechanical switch, which is used to control the state of the fluidic switch 202.

The fluidic switch 202 of FIG. 2 is a type of “Deans switch.” The fluidic switch 202 includes a first switching port 206 and a second switching port 208. The first and second switching ports 206 and 208 are coupled by channels 210 and 212 to first and second output ports 214 and 216, respectively. Thus, by virtue of the channels 210 and 212, the first and second switching ports 206 and 208 are in fluid communication with the first and second output ports 214 and 216, respectively.

The fluidic switch 202 also includes an input port 218, into which chromatographic effluent may be delivered. The input port 218 is coupled to each of the output ports 214 and 216 by channels 220 and 222, and is therefore in fluid communication with each of the output ports 214 and 216.

During operation, chromatographic effluent is pumped into the fluidic switch via the input port 218. At the same time, steering fluid may be pumped into either the first or second switching port 206 and 208. Assuming that steering fluid is pumped into the first switching port 206 (as is shown in the example depicted in FIG. 2), then the steering fluid flows through the fluidic switch 202 by way of channel 210, whereupon a majority of the steering fluid exits the fluidic switch 202 at the first output port 214. However, because the steering fluid is pumped through the fluidic switch 202 at a pressure higher than that of the chromatographic effluent, a relatively small portion of the steering fluid traverses the channel 220 interconnecting the first output port 220 and the input port 218. Upon reaching the input port 218, the steering fluid commingles with the chromatographic effluent, and drives the chromatographic effluent through channel 222 toward the output port 216, whereupon the chromatographic effluent exits the second output port 216. Of course, by virtue of the same physical principles just described, delivery of steering fluid to the second switching port 208 causes the chromatographic effluent to be directed toward the first output port 214.

The fluidic switching scheme just described yields a fast and sharp switching action that involves no moving parts. Further, even a relatively small steering fluid current is sufficient to cause the switching action to occur. Additionally, the aforementioned switching scheme may be effective at high temperatures, such as up to approximately 300° C.

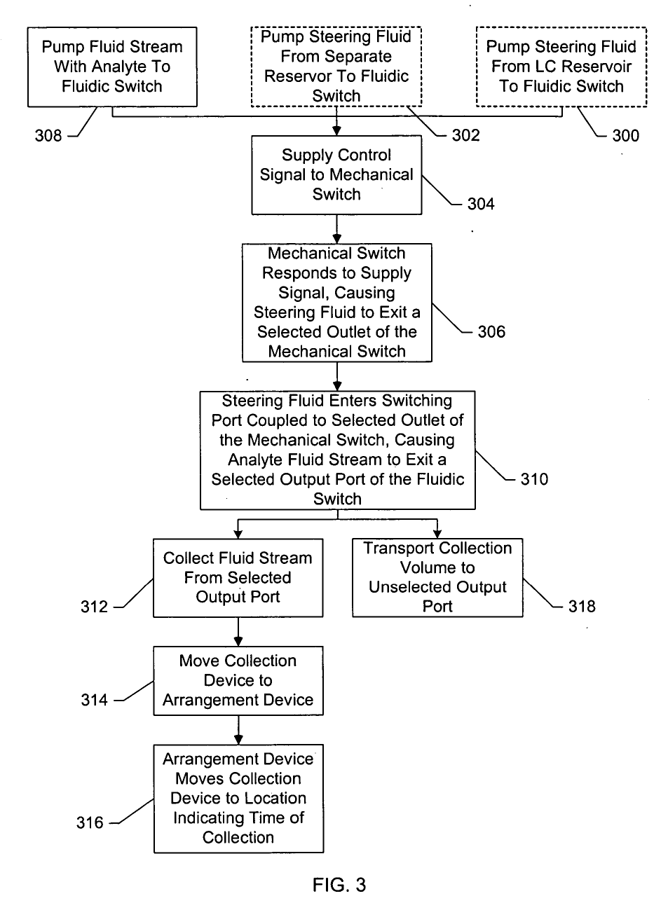

The system of FIG. 2 may be used according to the method depicted in FIG. 3 (the following discussion makes reference to both FIGS. 2 and 3). As shown in FIG. 3, steering fluid may be pumped, from the same reservoir that contains the mobile phase fluid (i.e., the mobile phase fluid is used as steering fluid), or from a separate reservoir (i.e., the steering fluid may have a different chemical composition than that of the mobile phase fluid), to the mechanical switch 204, as shown in operations 300 and 302, respectively.

The mechanical switch 204 is supplied with a control signal (operation 304). The mechanical switch 204 is configured to respond to the control signal by assuming a state wherein the steering fluid is directed to one of two outlets (operation 306). In other words, if the control signal indicates that the steering fluid is to be directed to the first outlet of the mechanical switch 204, then the input port of the mechanical switch 204 is coupled to its first outlet. On the other hand, if the control signal indicates that the steering fluid is to be directed to the second outlet of the mechanical switch 204, then the input port of the mechanical switch 204 is coupled to its second outlet. Consequently, the steering fluid exits the mechanical switch 204 via a selected outlet, and enters the fluidic switch 202 via the switching port 206 or 208 coupled to the selected outlet.

Meanwhile, as shown in operation 308, chromatographic effluent may be pumped from a source 226 (such as from the chromatograph) to the input port 218 of the fluidic switch 202. Notably, the pressure at which the steering fluid is pumped through the fluidic switch exceeds that of the chromatographic effluent. Thus, if steering fluid enters the fluidic switch 202 via the first switching port 206, then, as mentioned previously, a portion of the steering fluid traverses channel 210 and channel 220, commingles with the chromatographic effluent, and exits the fluidic switch via the second output port 216. On the other hand, if steering fluid enters the fluidic switch 202 via the second switching port 208, then a portion of the steering fluid traverses channel 212 and channel 222, commingles with the chromatographic effluent, and exits the fluidic switch via the first output port 214. Thus, as depicted in operation 310, the output port 214 or 216 by which the chromatographic effluent exits the fluidic switch 202 is determined by which switching port 206 or 208 the steering fluid enters the fluidic switch 202 (which, in turn, is determined by the state of the mechanical switch 204).

After egress from the selected switching port 206 or 208, the chromatographic effluent is received by a collection device 228, as depicted in operation 312. After being filled with effluent, a collection device 228 is carried (e.g., by the track system) to an arrangement device, such as a robotic arm, as depicted in operation 314. The arrangement device receives the collection device 228, and positions the collection device 228 at a location, such as a location on a tray, that indicates when the particular collection device 228 was filled relative to the other collection devices (operation 316). For example, the arrangement device may position the collection devices 228 according to a scheme in which the first-filled collection device occupies the upper left hand corner of a tray. The collection device occupying the position immediately to the right of the aforementioned first-filled device is the second-filled collection device, and so on. Meanwhile, while the collection device 228 is receiving the effluent emanating from the active output port, another collection device is transported to a filling position corresponding to the inactive output port (operation 318).

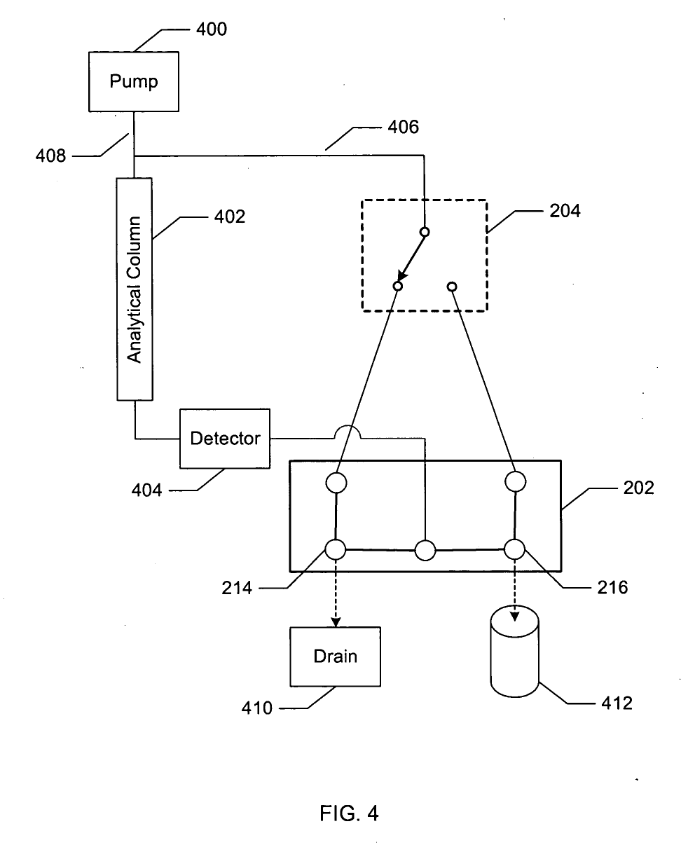

FIG. 4 depicts an embodiment of the system 200 of FIG. 2. The embodiment depicted in FIG. 4 includes the fluidic switch 202 and the mechanical switch 204. The embodiment further includes a pump 400 which drives a mobile phase liquid to an input port of a liquid chromatographic column 402. Prior to injection into the column, the substance to be analyzed is dissolved in the mobile phase fluid. The effluent from the column 402 is driven through a detector 404, such as an ultraviolet detector, and is ultimately delivered to the fluidic switch 202 for fraction collection, as described with reference to FIGS. 2 and 3.

As depicted in FIG. 4, an input line 406 feeding the mechanical switch 204 is tapped (“T-ed”)into tubing 408 that delivers the mobile phase fluid from the pump 400 to the column 402. Hence, according to the embodiment of FIG. 4, the mechanical switch uses mobile phase fluid as steering fluid. This arrangement has the advantage of making dual use of the mobile phase fluid, and requiring but a single pump 400. On the other hand, a separate supply of steering fluid, different in chemical composition from that of the mobile phase fluid, may be used, in which case the system may utilize a second pump for delivery of the steering fluid to the mechanical switch 204. Such an arrangement may be preferable when, for example, the mobile phase fluid is of a chemical composition that is destructive of the switch 204.

Also depicted in FIG. 4 is a drain 410. The drain 410 is depicted as being positioned beneath the first output port 214 (which, in the context of the example described with reference to FIG. 2 is the inactive output port). Thus, in the period of time following removal of the collection device from the filling position beneath the output port, and preceding introduction of a new collection device, steering fluid that exits the first output port 214 is received by the drain 410. Although not depicted in FIG. 4, a second drain is positioned beneath the second output port 216. While an output port is active, a collection device 412 is interposed between the drain and the fluidic switch 202.

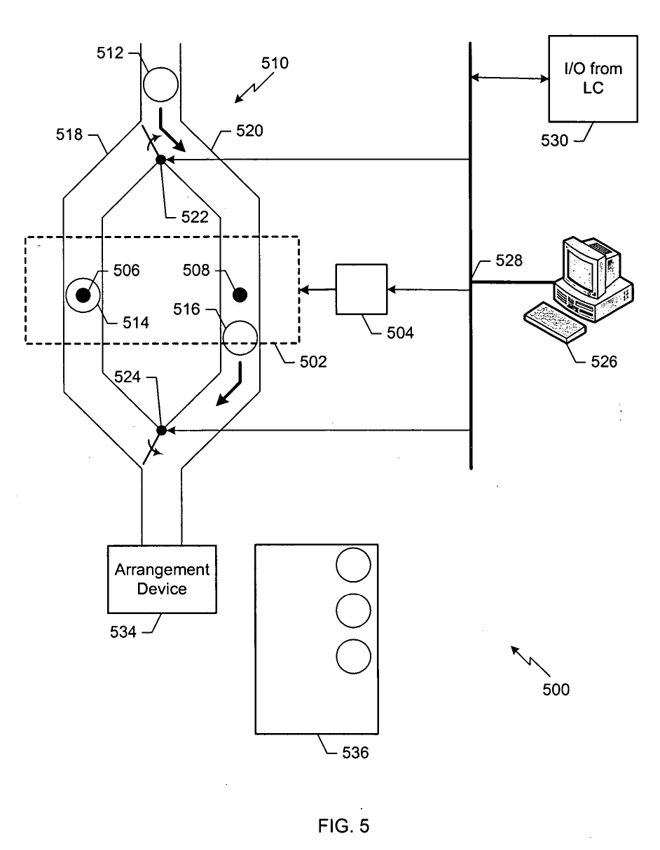

FIG. 5 depicts an embodiment of a system 500 for fraction collection. The system 500 is shown from a top view. The system 500 includes a fluidic switch 502 and a control device 504 that controls the state of the fluidic switch 502, as has been discussed previously. Darkened dots 506 and 508 represent the output ports of the fluidic switch 502.

A track system 510 conveys collection devices 512-516 to and from the output ports 506 and 508 of the fluidic switch 502. The track system 510 includes two branches: a first branch 518 that conveys collection devices to and from the first output port 506, and a second branch 520 that conveys collection devices to and from the second output port 508.

The system 500 of FIG. 5 operates in accordance with the principles of the method of FIG. 3. As can be seen from FIG. 3, a first collection device 514 is located at a filling location to receive effluent from the fluidic switch 502. At the same time, a second (filled) collection device is being conveyed away from the second output port 508, and a third collection device 512 is being conveyed to that port 508. Thus, at the instant depicted in FIG. 5, branch 518 is controlled to be static, while branch 520 is in motion.

A first sequencer 522 and a second sequencer 524 are located proximate the intersection of the first and second branches 518 and 520. The first sequencer 522 causes a collection device (such as collection device 512) to selectively traverse either the first or second branch 518 or 520 of the track system 510. The second sequencer 524 assists in returning a collection device from the first or second branches 518 or 520.

The system 500 of FIG. 5 includes a computing system 526. The computing system 526 may be embodied as a single computer, or multiple computers that cooperate with one another to achieve the results described below.

The computing system 526 includes one or more input/output (I/O) channels 528, which permit the communication of data and control signals between the computer system 526 and the first sequencer 522, the second sequencer 524, the control device 504, and the liquid chromatograph 530. For example, the computing system 526 may include a network interface card (NIC) that couples the computing system to a local area network (LAN) to which the aforementioned devices are also coupled. Per such an embodiment, the computing system 526 and the aforementioned devices communicate via the LAN. Alternatively, each of the devices may be coupled to a corresponding peripheral card that is connected to an I/O bus in the computing system 526. Thus, the computing system 526 communicates with a given device by directing I/O commands to a particular peripheral card, and therefore to a particular device. Other schemes for communicating with devices are known and are included within the scope of this disclosure.

The computing system 526 communicates control signals to the control device 504 and to the first and second sequencers 522 and 524. The computing system 526 is programmed to deliver control signals to the control device 504, so as to cause the control device 504 to perform an act resulting in the fluidic switch 502 transitioning to a desired state. For example, according to one embodiment, the control device 504 is a switch arranged as discussed with reference to FIG. 2, and the computing system 526 communicates a first control signal thereto, in order to cause the switch 504 to deliver steering fluid to a desired switching port. Thus, the computing system 526 controls the state of the fluidic switch 502.

The computing system 526 may be programmed to control the state of the fluidic switch according to any timing scheme. For example, the computing system 526 may cause the fluidic switch to alternate at regular intervals between first and second states, in a first-state-second-state-first-state sort of pattern. According to another example, the computing system 526 may cause state transitions at irregular intervals, so that a particular collection device receives effluent having exited the chromatograph at a particular time.

The computing system 526 also communicates control signals to the first and second sequencers 522 and 524. Therefore, the computing system 526 causes a collection device (such as 512) to traverse one branch (such as branch 520) of the track system 510, while the other branch (such as branch 518) remains static, so as to permit collection.

The computing system 526 runs an internal clock and records the time period during which a given collection device 512-516 receives effluent from the fluidic switch (filling time). The computing system 526 also receives data from the liquid chromatograph 530, and combines the data therefrom to create a data record corresponding to each collection device. For example, the computing system may associate a retention time and a filling time with each collection device, amongst other data.

After being filled with effluent, a collection device 512-516 is carried by the track system 510 to an arrangement device 534, such as a robotic arm. The arrangement device 534 receives a collection device 512-516, and positions the collection device 512-516 at a location on a tray 536 that indicates when the particular collection device was filled relative to the other collection devices. For example, the arrangement device 534 may position the collection devices according to a scheme in which the first-filled collection device occupies the upper left hand corner of the tray. The collection device occupying the position immediately to the right of the aforementioned first-filled device is the second-filled device, and so on.

The embodiments of the fluidic switch depicted herein have been described as being used in connection with high performance liquid chromatography. The switch is not so limited in its use, however. The switch may be used in any setting in which fluid needs to be collected.

Aspects of the embodiment described as being carried out by the computing system 526 or otherwise described as a method of control or manipulation of data may be implemented in one or a combination of hardware, firmware, and software. Embodiments may also be implemented as instructions stored on a machine-readable medium, which may be read and executed by at least one processor to perform the operations described herein. A machine-readable medium may include any mechanism for storing or transmitting information in a form readable by a machine (e.g., a computer). For example, a machine-readable medium may include read-only memory (ROM), random-access memory (RAM), magnetic disc storage media, optical storage media, flash-memory devices, electrical, optical, acoustical or other form of propagated signals (e.g., carrier waves, infrared signals, digital signals, etc.), and others.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

1. A method of fraction collection comprising:
providing a fluid stream including an analyte to a fluidic switch having a first output port and a second output port;
providing a steering fluid to the fluidic switch, so as to selectively steer the analyte to a selected one of the first or second output ports;
collecting the analyte from the selected output port in a first collection device; and
moving a second collection device under the unselected output port of the switch during at least a portion of time during which the analyte is being collected.

2. The method of claim 1, wherein the act of providing the steering fluid comprises:
pumping steering fluid through a mechanical switch having first and second outlets, wherein the first outlet of the mechanical switch is coupled to a first switching port of the fluidic switch, and wherein the second outlet of the mechanical switch is coupled to a second switching port of the fluidic switch; and
controlling the mechanical switch, so as to selectively direct the steering fluid to a selected one of the first or second outlets of the mechanical switch, and thereby to either the first or second switching port of the fluidic switch.

3. The method of claim 2, wherein the mechanical switch is controlled according a control signal.

4. The method of claim 1, wherein the steering fluid is drawn from a supply of mobile phase fluid that is also drawn upon for moving the analyte through a column of a liquid chromatograph prior to fraction collection.

5. The method of claim 1, wherein the steering fluid is different from mobile phase fluid that moves the analyte through a column of a liquid chromatograph.

6. The method of claim 1, further comprising:
moving the first collection device to a sequencer after the collection of the analyte; and
using the sequencer to direct the first collection device to a physical location indicative of when the first collection device was used for collection relative to other collection devices.

7. The method of claim 6, wherein the sequencer directs the first collection device to a location within a sequential train of collection vials.

8. The method of claim 6, further comprising positioning the first collection device on a tray, wherein the location of the first collection device on the tray indicates when the first collection device was used for collection relative to other collection devices.

9. The method of claim 1, wherein the collection device comprises a vial or plate.

10. The method of claim 1, wherein the fluidic switch comprises a Deans switch.

11. A system for fraction collection, comprising:
a fluidic switch having a first output port and a second output port, the fluidic switch being configured to receive a fluid stream from a liquid chromatography device via a fluid stream input port, wherein the fluidic switch may be controlled to be in a first state in which the fluid stream is steered to the first output port, or a second state in which the fluid stream is steered to the second output port; and
a control device that determines the state of the fluidic switch, thereby determining whether the fluid stream exits the fluidic switch via the first output port or the second output port.

12. The system of claim 11, wherein the control device comprises:
a mechanical switch having first and second outlets, wherein the first outlet of the mechanical switch is coupled to a first switching port of the fluidic switch, wherein the second outlet of the mechanical switch is coupled to a second switching port of the fluidic switch, wherein the mechanical switch is configured to selectively direct the steering fluid to a selected one of the first or second outlets of the mechanical switch.

13. The system of claim 12, wherein the fluidic switch is configured to direct the fluid stream including the analyte to the second output port, during periods when the steering fluid is received by the first switching port, and to direct the fluid stream including the analyte to the first output port, during periods when the steering fluid is received by the second switching port.

14. The system of claim 12, wherein the fluidic switch further comprises:
a channel providing fluid communication between the first switching port and the first output port;
a channel providing fluid communication between the second switching port and the second output port;
a fluid stream input port;
a channel providing fluid communication between the fluid stream input port and the first output port; and
a channel providing fluid communication between the fluid stream input port and the second output port.

15. The system of claim 11, further comprising:
a source of empty collection devices;
a conveyance system configured to move one of the empty collection devices proximate to a selected one of the first or second output ports.

16. The system of claim 15, wherein the collection devices comprise vials or dishes.

17. The system of claim 11, further comprising a liquid chromatography device coupled to the fluidic switch.

18. The system of claim 11, further comprising a sequencer configured to a collection device to a physical location indicative of when the collection device was filled, relative to other collection devices.

19. The system of claim 18, wherein the sequencer is configured to direct the collection device to a location within a sequential train of collection vials.

20. The system of claim 11, further comprising a controller circuit configured to generate signals, based upon which the control device is configured to determine the state of the fluidic switch.

21. A system for fraction collection, comprising:
a means for directing samples of substantially all of a fluid stream into a plurality of collection devices; and
a means for directing the collection devices to the directing means, so that each collection device may be filled with a sample of the fluid stream.

22. The system of claim 21, wherein the directing means comprises a fluidic switch.

23. The system of claim 22, wherein the fluidic switch is configured to operate in at least two states, and wherein the system further comprises a means for controlling the state of the fluidic switch.

24. The system of claim 23, wherein the means for controlling the state of the fluidic switch comprises a mechanical switch.

25. The system of claim 22, further comprising a means for directing the collection devices from the fluidic switch to a physical location indicative of when each collection device was filled, relative to the other collection devices.
